(19) United States
(12) Patent Application Publication
(10) Pub. No.: US 2010/0306780 A1
(43) Pub. Date: Dec. 2, 2010

(54) JOB ASSIGNING APPARATUS, AND CONTROL PROGRAM AND CONTROL METHOD FOR JOB ASSIGNING APPARATUS

(75) Inventor: Toshiaki MIKAMO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/853,665

(22) Filed: Aug. 10, 2010

Related U.S. Application Data
(63) Continuation of application No. PCT/JP2008/054639, filed on Mar. 13, 2008.

(51) Int. Cl. G06F 9/50

(52) U.S. Cl. 718/104

(57) ABSTRACT

A job assigning apparatus which is connected to a plurality of job processors and assigns the job to any of the job processors includes: an accepting section that accepts the job; an assigning section that selects a job processor having the least number of processes and assigns the accepted job to the selected job processor; a managing section that manages each of the job processors and the number of processes of the job assigned to each of the job processors by the assigning section in association with each other; an adding section that adds the number of processes of the jobs assigned by the assigning section to the number of processes managed by the managing section; and a notifying section that notifies another job assigning apparatus for assigning a job to a job processor of the number of processes of the job assigned by the assigning section.

### CROSS-REFERENCE TO RELATED APPLICATIONS

This application is a continuation application, filed under 35 U.S.C. §111(a), of PCT Application No. PCT/JP2008/054639, filed Mar. 13, 2008, the disclosure of which is herein incorporated in its entirety by reference.

### FIELD

The technique disclosed in this application relates to a job assigning apparatus, and control program and control method for job assigning apparatus.

### BACKGROUND

There is conventionally known a cluster system in which a number of users use one or a plurality of computers to perform calculation (hereinafter, this calculation is referred to as “job”) through interactive processing like TSS (Time Sharing System). In such a cluster system, a processing unit to execute a program in a calculation node for processing a job is referred to as a “process”. For example, a job to be submitted to the cluster system includes a parallel job composed of a plurality of processes and a sequential job composed of one process. The cluster system is constituted by a login node which is a computer used for a user to login and submit a job to the system and a calculation node which is a computer for processing the submitted job. With recent improvement in network performance, the cluster system can include several thousands of calculation nodes.

The cluster system processes jobs submitted by a number of users using a low-load calculation node to thereby improve the availability of the overall system. CPU (Central Processing Unit) utilization in each calculation node or number of processes assigned to each calculation node can be used as an index for the load of each calculation node. However, the load level represented by the CPU utilization may be transient. For example, there may be a case where additional jobs are submitted due to accidental low CPU utilization at the time of measurement even though a number of jobs have been submitted to the calculation load. Therefore, the number of processes assigned to the calculation node is often used as an index of the load.

Hereinafter, the abovementioned cluster system that uses the number of processes assigned to the calculation node as an index of the load will be described. FIG. 9 is a view illustrating a conventional cluster system. FIG. 10 is a view illustrating another conventional cluster system.

As illustrated in FIG. 9, a conventional cluster system includes a management node 30, a login node 40, and a calculation node 50. The management node 30 has a load information DB (database) 31. The load information DB 31 manages the calculation node 50 and the number of processes assigned to the calculation node 50. In this conventional cluster system, the login node 40 asks the management node 30 for a low-load calculation node 50. In response to this, the management node 30 refers to the load information DB 31, selects a calculation node 50 to which the least number of processes are assigned, notifies the login node 40 of the selected calculation node 50, and updates the load information DB 31 with respect to the number of processes of the notified calculation node 50.

As described above, the management node 30 in the conventional cluster system can select a calculation node 50 having the least load and notify the login node 40 of the selected calculation node.

Another conventional cluster system illustrated in FIG. 10 includes a NAS (Network Attached Storage) 60, a login node 70, and a calculation node 50. That is, the cluster system of FIG. 10 differs from that illustrated in FIG. 9 in the point of having the NAS 60 in place of the management node 60 and having the login node 70 that performs an operation different from an operation performed by the login node 40 in place thereof.

In this another conventional cluster system, the NAS 60 has a load information DB 61 for managing the number of processes assigned to the calculation node 50, and the login node 70 refers to the load information DB 61, selects a calculation node 50 to which the least number of processes are assigned, and updates the load information DB 61 with respect to the selected calculation node 50.

As described above, the login node 70 in the conventional cluster system can select a calculation node 50 having the least load by referring to the load information DB 61 of the NAS 60.

The following technique has been disclosed as a prior art relevant to the present invention.
[Patent Document 1] Japanese Laid-Open Patent Publication No. 7-319834

### SUMMARY

According to an aspect of the embodiment, there is provided a computer-readable recording medium that stores a control program allowing a computer connected to a plurality of job processors for processing a job to execute processing of assigning the job to any of the plurality of job processors, the control program including: accepting the job; selecting a job processor in which the number of processes which is the number of processing units of a job already assigned to each of the job processors is least from among the plurality of job processors and assigning the accepted job to the selected job processor; managing each of the job processors and the number of processes of the job assigned to each of the job processors in association with each other; adding, in the job processor to which the job is assigned, the number of processes of the assigned job to the number of processes associated with the job; and notifying another job assigning apparatus for assigning a job to a job processor of the number of processes of the assigned job.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a cluster system according to the present embodiment;

FIG. 2 is a view illustrating a configuration of a login node in the cluster system according to the present embodiment;

FIG. 3 is a view illustrating a process table;

FIG. 4 is a view illustrating a configuration of a calculation node in the cluster system according to the present embodiment;

FIG. 5 is a flowchart illustrating operation of job submission processing;

FIG. 6 is a flowchart illustrating operation of job termination processing;

FIG. 7 is a flowchart illustrating operation of failure detection processing;

FIG. 8 is a flowchart illustrating operation of restoration processing;

FIG. 9 is a view illustrating a conventional cluster system; and

FIG. 10 is a view illustrating another conventional cluster system.

### DESCRIPTION OF EMBODIMENT

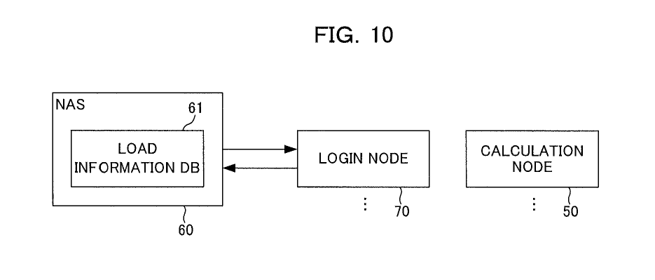

Problems encountered in the cluster systems of FIGS. 9 and 10 will be described. The conventional cluster system illustrated in FIG. 9 has a problem in that when the number of the calculation nodes 50 and the number of login nodes 40 are large, the load on the management server 30 or a file server involved with the cluster system is increased to cause response degradation in the interactive processing, resulting in reduction in performance of the overall system.

The another conventional cluster system illustrated in FIG. 10 has a problem in that when the NAS 60 having the load information DB 61 is failed, or a management node or file server involved with the another conventional cluster system is failed, load distribution may not be achieved, resulting in degradation of reliability.

To solve the above problems, an object of the present embodiment is to provide a technique capable of distributing processing load associated with system management and realizing a highly reliable system.

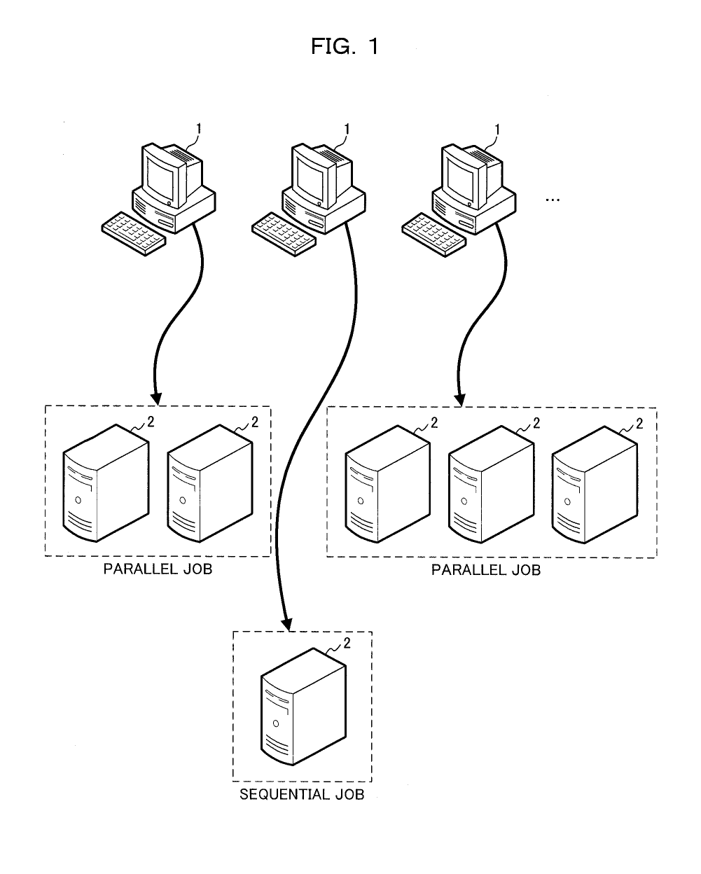

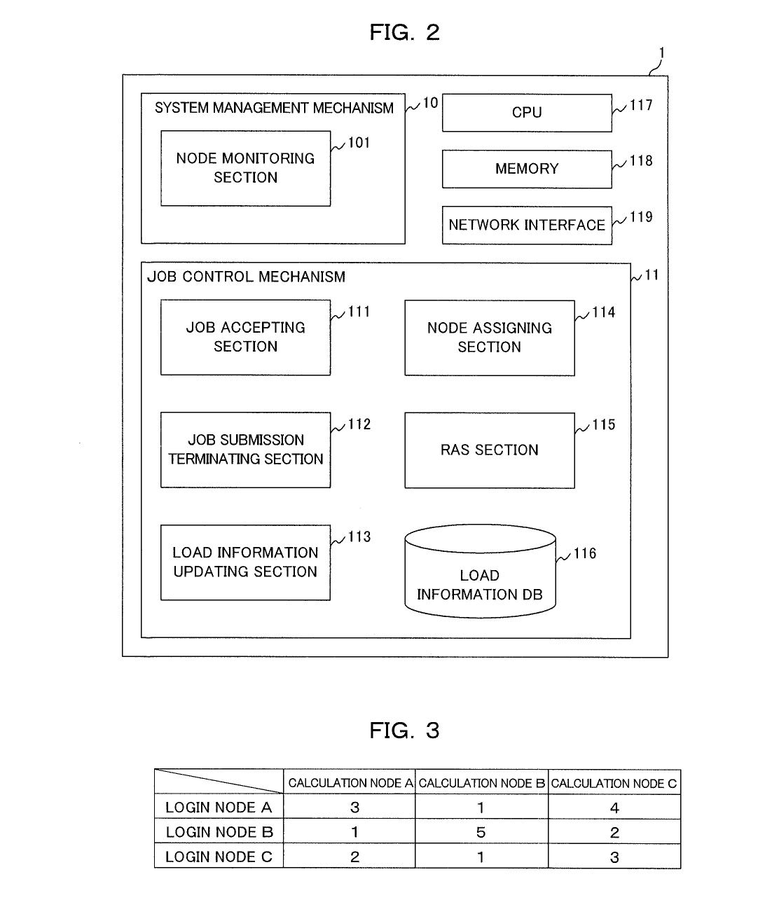

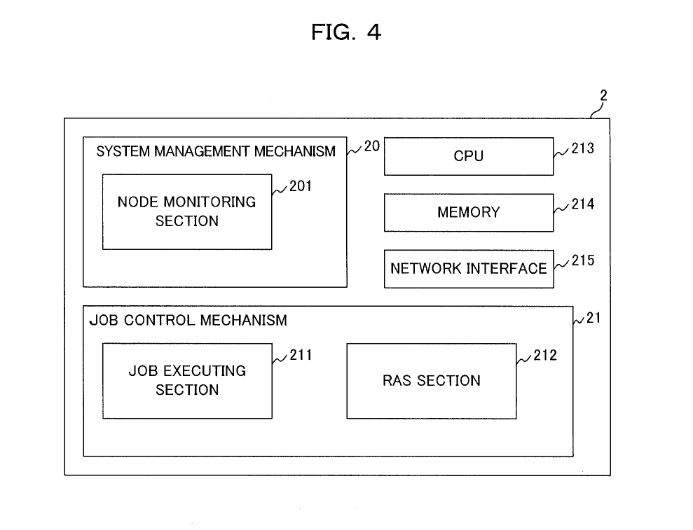

First, a cluster system according to the present embodiment will be described. FIG. 1 is a view illustrating a cluster system according to the present embodiment. FIG. 2 is a view illustrating a configuration of a login node in the cluster system according to the present embodiment. FIG. 3 is a view illustrating a process table. FIG. 4 is a view illustrating a configuration of a calculation node in the cluster system according to the present embodiment.

As illustrated in FIG. 1, a cluster system according to the present embodiment includes login node 1 (job assigning apparatus, another job assigning apparatus) and a calculation node (job processor) 2. In this cluster system, a user logs in to the login node 1 using, e.g., a DNS round-robin function. The calculation node 2 executes a parallel job or a sequential job, and the login node 1 determines to which calculation node 2 a job is submitted based on the job type or load on the calculation node 2.

The login node 1 includes, as illustrated in FIG. 2, a system management mechanism 10, a job control mechanism 11, a CPU 117, a memory 118, and a network interface 119. The system management mechanism 10 of the login node 1 includes a node monitoring section 101. The job control mechanism 11 includes a job accepting section 111 (accepting section), a job submission terminating section 112 (subtracting section), a load information updating section 113 (managing section, updating section, subtracting section), a node assigning section 114 (assigning section, notifying section, adding section, updating section, receiving section, acquiring section), an RAS (Reliability Availability Serviceability) section 115 (reception section, subtracting section), and a load information DB 116.

The functions of the respective components constituting the system management mechanism 10 and job control mechanism 11 will roughly be described below. The details of operations of the respective components will be described later along with the operation of the login node 1. The node monitoring section 101 monitors a state of the login node 1 (whether the login node 1 is activated or not) and notifies another login node 1 and calculation node 2 of a change in the state of the login node 1. The job accepting section 111 authenticates a user of the login node 1 and accepts the number of processes of a job that the authenticated user submits, the number of nodes to be assigned to the job, and a program name corresponding to the job. The job submission terminating section 112 requires the calculation nodes to which the job has been assigned to generate and execute job processes. The load information updating section 113 refers to and updates the load information DB 116 the details of which will be described later. The node assigning section 114 selects a calculation node 2 having the least number of processes in the load information DB 116. The RAS section 115 updates the load information DB 116 based on information of another login node 1 transmitted by the system management mechanism 10 of the another login node 1. The load information DB 116 manages a process table illustrated in FIG. 3. The memory 116 is a memory device, such as ROM (Read Only Memory), RAM (Random Access Memory), or FLASH memory that stores the abovementioned components as programs. The CPU 117 is a calculation unit for executing the respective components which are stored in the memory 116 as programs. The network interface 119 is an interface for the login node 1 to connect to a network. The system management mechanism 10 may be implemented as hardware. The notification processing and transmission/reception processing in the login node 1 are performed through the network interface 119.

A description is given here of the process table. As illustrated in FIG. 3, the process table manages the login node 1 and calculation node 2 constituting the cluster system in association with each other. Although the calculation nodes 2 are listed alphabetically in the process table of FIG. 3, the calculation nodes 2 may be sorted in ascending order in terms of the number of assigned processes in order to alleviate the load on the login node 1 during selection processing of a calculation node having the least number of processes.

The calculation node 2 includes, as illustrated in FIG. 4, a system management mechanism 20 and a job control mechanism 21. The system management mechanism 20 includes a node monitoring section 201. The job control mechanism 21 includes a job executing section 211 and an RAS section 212.

The functions of the respective components constituting the system management mechanism 20 and job control mechanism 21 will roughly be described below. The node monitoring section 201 monitors a state of the login node 1 and notifies another login node 1 and calculation node 2 of a change in the state of the login node 1. The job executing section 211 receives a process generation request from the login node 1 and executes the process. The RAS section 212 receives information relevant to a change in the state of another calculation node. A memory 214 is a memory device, such as ROM, RAM, or FLASH memory that stores the abovementioned components as programs. A CPU 213 is a calculation unit for executing the respective components which are stored in the memory 214 as programs. A network interface 215 is an interface for the calculation node 2 to connect to a network. The monitoring processing, notification processing and transmission/reception processing in the calculation node 2 are performed through the network interface 215.

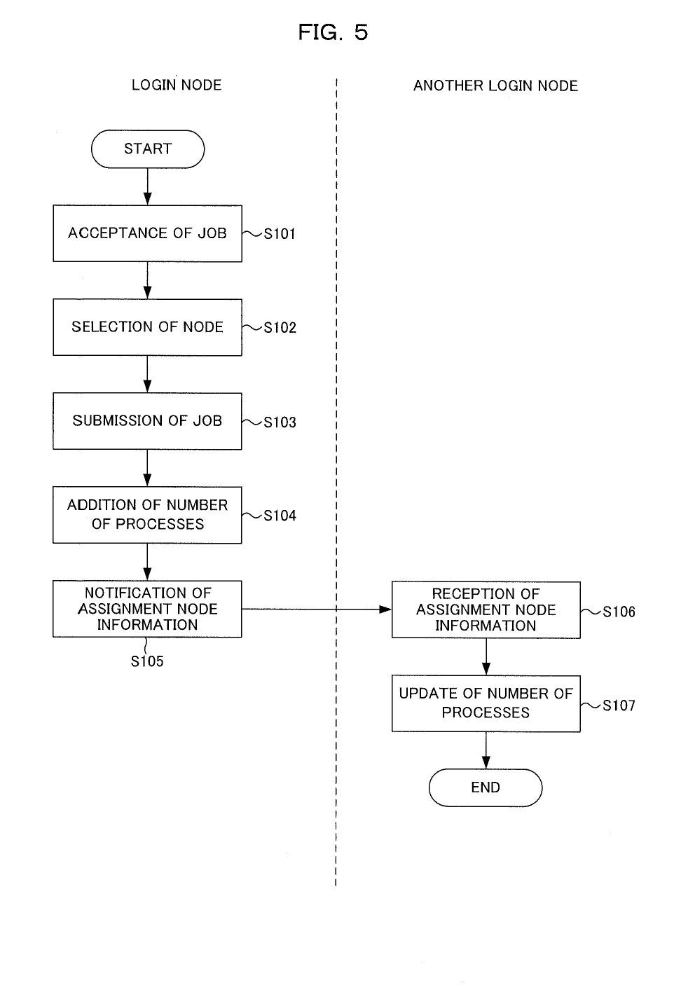

Next, operation of the cluster system according to the present embodiment will be described. First, job submission processing will be described. FIG. 5 is a flowchart illustrating operation of the job submission processing.

The job accepting section 111 of the login node 1 accepts a job that a user submits through interactive processing (S101, job accepting step). Then, the load information updating section 113 refers to the process table of the load information DB, and the node assigning section 114 selects a calculation node 2 having the least number of processes based on the referenced process table (S102, job assigning step) and assigns the submitted job to the selected calculation node 2 (S103, job assigning step). After that, the node assigning section 114 determines the number of processes to be assigned to the calculation node 2 based on the submitted job and adds the number of processes assigned to the selected calculation node 2 in the process table of the load information DB (S104, first adding step).

The node assigning section 114 notifies another login node 1 of assignment node information including the calculation node 2 to which the job has been assigned and the number of processes assigned to the calculation node 2 (S105, first notification step).

The node assigning section 114 of the another login node 1 receives the assignment node information from the login node 1 (S106, first receiving step) and updates the number of processes assigned to the calculation node 2 based on the received assignment node information (S107, first updating step).

As described above, the login node 1 notifies another login node 1 of the calculation node 2 to which the job has been submitted and the number of processes assigned to the calculation node 2, whereby the number of processes assigned to the calculation node 2 can be shared among the login nodes 1 in the cluster system. Although the number of job processes assigned to the calculation node 2 is added in the process table in FIG. 5, the number of job processes submitted to the calculation node 2 may be added in the process table.

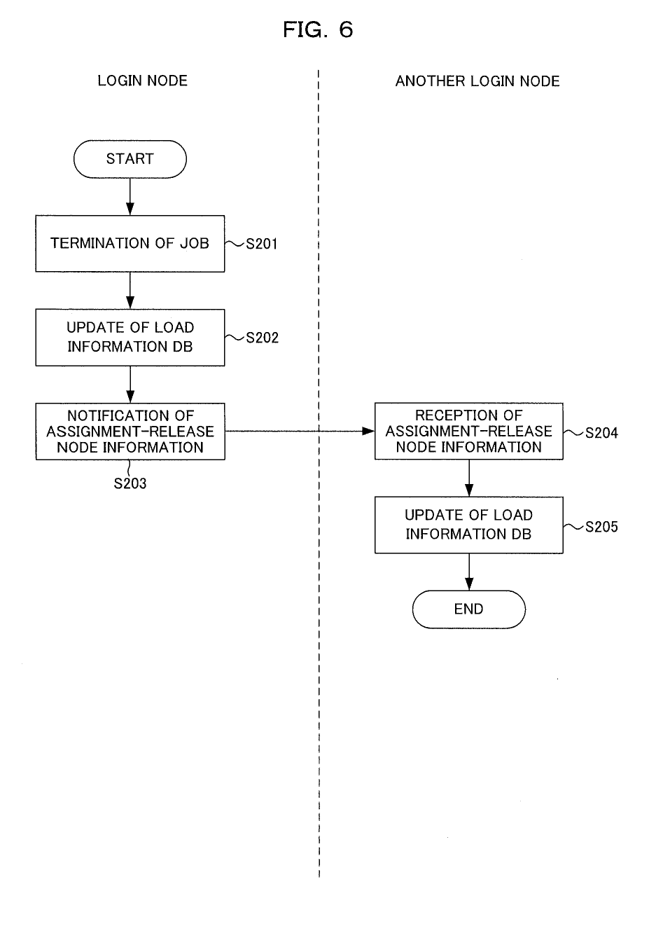

Next, job termination processing will be described. The job termination processing is performed by the login node at the time when the job submitted to the calculation node by the above job submission processing is terminated. FIG. 6 is a flowchart illustrating operation of the job termination processing.

The job submission terminating section 112 of the login node 1 receives termination notification of the submitted job from the job executing section 211 of the calculation node 2 (S201, second subtracting step), and the load information updating section 113 updates the load information DB 116 (S202, second subtracting step). More specifically, the load information updating section 113 subtracts the number of terminated processes from the number of processes assigned to the calculation node 2.

Subsequently, the node assigning section 114 of the login node 1 notifies another login node 1 of the calculation node 2 that has terminated the job submitted thereto and the number of processes assigned to the calculation node 2 as assignment-release node information (S203, second notification step).

The node assigning section 114 of another login node 1 receives the assignment-release node information from the login node 1 (S204, second receiving step), and the load information updating section 113 updates the load information DB 116 based on the assignment-release node information (S205, third subtracting step). More specifically, the load information updating section 113 subtracts the number of processes of the calculation node 2 indicated in the received assignment-release node information from the process table.

As described above, upon termination of the job submitted to the calculation node 2, the login node 1 notifies another login node 1 of the calculation node 2 that has terminated the job and the number of processes assigned to the calculation node 2, whereby the number of processes terminated in the calculation node 2 can be shared among the login nodes 1 in the cluster system.

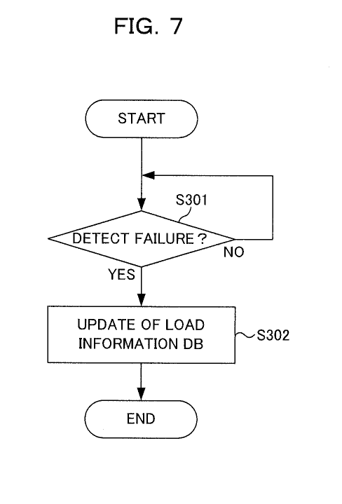

Next, failure detection processing will be described. The failure detection processing detects a failed login node based on a change in the state (whether another node is activated or not) of another login node. FIG. 7 is a flowchart illustrating operation of the failure detection processing. In the present embodiment, it is assumed that when a login node which is the process assignment source is failed, the calculation node forcibly terminates the processes assigned by the failed login node. This is because that the session is closed upon failure of the login node, which makes further process execution of the calculation node meaningless.

The node monitoring section 101 of the login node 1 determines whether or not failure notification (operation stop information) indicating failure of another login node 1 is received for failure detection (S301, operation stop information receiving step).

If the failure notification is received (YES in S301), the load information updating section 113 of the login node 1 updates the load information DB (S302, first subtracting step). More specifically, the load information updating section 113 performs subtraction by zero-clearing, in the process table, the number of processes assigned to the calculation node 2 by the another login node 1 the failure notification of which has been issued.

On the other hand, if the failure notification is not received (NO in S301), the node monitoring section 101 of the login node 1 determines once again whether or not the failure notification of another login node 1 is received (S301).

As described above, the login node 1 zero-clears, in the process table, the number of processes assigned to the calculation node 2 by the another login node 1 the failure of which has been detected, whereby the login node 1 can grasp the number of processes that is currently assigned to the calculation node 2.

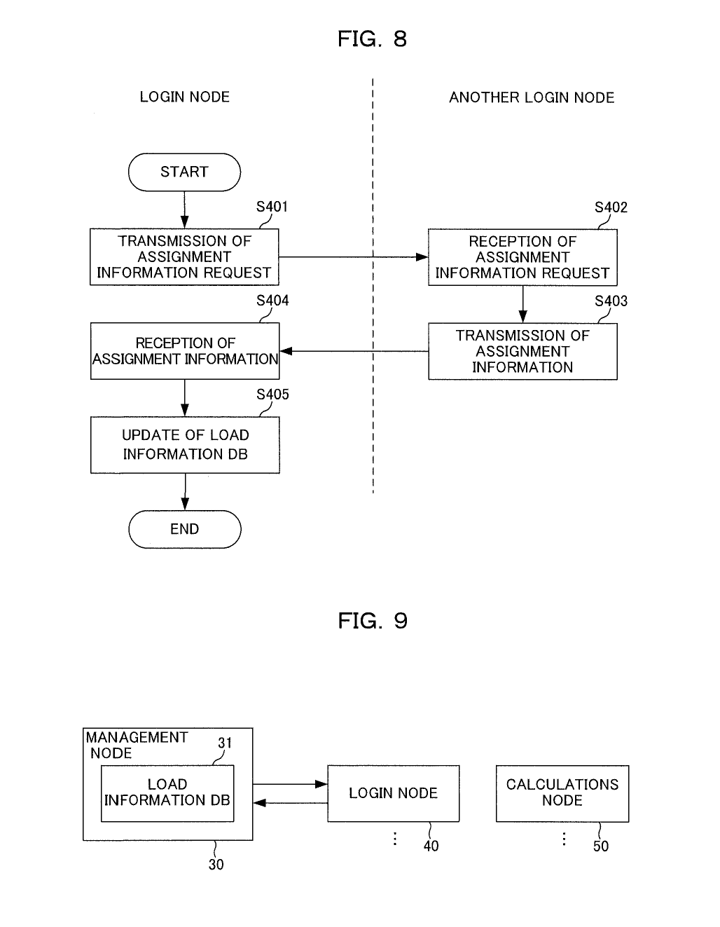

Next, restoration processing will be described. The restoration processing is executed when the failed login node is normally activated. FIG. 8 is a flowchart illustrating operation of the restoration processing.

The node monitoring section 101 of the login node 1 notifies the node monitoring section 101 of another login node of the activation of the login node 1, and the RAS section 115 of the login node 1 requires the another login node 1 to transmit assignment information (S401, acquisition step). The assignment information is information indicating the number of processes that the another login node 1 has assigned to the calculation node 2 in the cluster system.

Subsequently, the RAS section 115 of the another login node 1 receives the activation notification of the login node 1, and the node assigning section 114 of the another login node 1 receives the request of the assignment information (S402) and, in response to this, transmits the assignment information to the login node 1 requesting the assignment information (S403).

After that, node assigning section 114 of the login node 1 receives the assignment information from the another login node 1 (S404, acquisition step), and the load information updating section 113 updates the process table of the load information DB based on the received assignment information (S405, second updating step).

As described above, at the time of the restoration, the login node 1 requests the another login node 1 to transmit the assignment information and updates the process table based on the received assignment information, whereby the login node 1 can grasp the number of processes assigned to the calculation node 2.

As described above, in the cluster system according to the present embodiment, providing the load information DB in the login node 1 eliminates the need for the calculation node 2 to have a node for managing the number of processes and a database for referencing the load information. Further, in the cluster system according to the present embodiment, management of the number of processes and assignment of the processes to the calculation node are performed by the login node 1, thereby realizing a system with high reliability without causing response degradation in the interactive processing.

It is possible to provide a program that allows a computer constituting the assigning apparatus to execute the above steps as a control program. By storing the above program in a computer-readable recording medium, it is possible to allow the computer constituting the assigning apparatus to execute the program. The computer-readable recording medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

As described above, it is possible to distribute processing load associated with system management and to realize a highly reliable system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A computer-readable recording medium storing a control program for directing a computer connected to a plurality of job processors to perform an operation of assigning a job to any of the plurality of job processors, the operation comprising:
accepting the job;
selecting a job processor in which the number of processes assigned to each of the job processors is least from among the plurality of job processors;
assigning the accepted job to the selected job processor;
managing each of the job processors and the number of processes of the job assigned to each of the job processors in association with each other;
adding the number of processes of the assigned job to the number of processes associated with the job in the job processor to which the job is assigned; and
notifying another computer for assigning a job to a job processor of the number of processes of the assigned job.

2. The computer-readable recording medium according to claim 1, wherein
the operation further comprising:
managing a job processor to which a job is assigned by the another computer and the number of processes of the job assigned to the job processor by the another computer in association with each other;
receiving notification indicating the number of processes of the job assigned to the job processor by the another computer from the another computer; and
updating the managed number of processes of the job assigned to the job processor by the another computer based on the received number of processes of the job assigned to the job processor by the another computer.

3. The computer-readable recording medium according to claim 1, wherein
the operation further comprising:
subtracting the number of processes of the terminated job from the number of processes of the job assigned to the job processor when receiving termination notification indicating that the job processor terminates the assigned job from the job processor; and
notifying the another computer of the number of processes of the job terminated in the job processor.

4. The computer-readable recording medium according to claim 2, wherein
the operation further comprising:
receiving the number of processes of the terminated job out of jobs assigned to the job processor by the another computer notified from the another computer; and
subtracting the number of processes of the terminated job notified from the another computer from the managed number of processes of the job assigned to the job processor.

5. The computer-readable recording medium according to claim 2, wherein
the operation further comprising:
receiving operation stop information indicating stop of operation of the another computer; and
subtracting the number of processes of the job assigned to the job processor by the another computer from the managed number of processes of the job assigned to the job processor upon receiving of the operation stop information.

6. The computer-readable recording medium according to claim 2, wherein
the operation further comprising:
acquiring the number of processes of the job assigned to the job processor by the another computer from the another computer upon activation of the job assigning apparatus; and
updating the managed number of processes of the job assigned to the job processor by the another computer based on the acquired number of processes of the job assigned to the job processor by the another computer.

7. A job assigning apparatus connected to a plurality of job processors for processing a job and assigns the job to the job processors, the job assigning apparatus comprising:
an accepting section that accepts the job;
an assigning section that selects a job processor in which the number of processes assigned to each of the job processors is least from among the plurality of job processors and assigns the accepted job to the selected job processor;
a managing section that manages each of the job processors and the number of processes of the job assigned to each of the job processors by the assigning section in association with each other;
an adding section that adds the number of processes of the jobs assigned by the assigning section to the number of processes managed by the managing section in the job processor to which the job is assigned by the assigning section; and
a notifying section that notifies another job assigning apparatus for assigning a job to a job processor of the number of processes of the job assigned by the assigning section.

8. The job assigning apparatus according to claim 7, further comprising:
a managing section that manages a job processor to which a job is assigned by the another job assigning apparatus and the number of processes of the job assigned to the job processor by the another job assigning apparatus in association with each other;
a receiving section that receives notification indicating the number of processes of the job assigned to the job processor by the another job assigning apparatus from the another job assigning apparatus; and
an updating section that updates the number of processes of the job assigned to the job processor by the another job assigning apparatus which is managed by the managing section based on the number of processes of the job assigned to the job processor by the another job assigning apparatus which is received by the receiving section.

9. The job assigning apparatus according to claim 7, further comprising:
a subtracting section that subtracts, the number of processes of the terminated job from the number of processes of the job assigned to the job processor when receiving termination notification indicating that the job processor terminates the assigned job from the job processor, wherein
the notifying section notifies the another job assigning apparatus of the number of processes of the job terminated in the job processor.

10. The job assigning apparatus according to claim 8, wherein
the receiving section receives the number of processes of the terminated job, out of jobs assigned to the job processor by the another job assigning apparatus, which is notified from the another job assigning apparatus, and
the subtracting section subtracts the number of processes of the terminated job notified from the another job assigning apparatus from the number of processes of the job assigned to the job processor which is managed by the managing section.

11. The job assigning apparatus according to claim 8, wherein the receiving section receives operation stop information indicating stop of operation of the another job assigning apparatus, and
the subtracting section subtracts the number of processes of the job assigned to the job processor by the another job assigning apparatus the operation stop notification of which has been issued from the number of processes of the job assigned to the job processor which is managed by the managing section when the receiving section receives the operation stop information.

12. The job assigning apparatus according to claim 8, further comprising:
an acquiring section that acquires, the number of processes of the job assigned to the job processor by the another job assigning apparatus from the another job assigning apparatus upon activation of the job assigning apparatus, wherein
the updating section updates the number of processes of the job assigned to the job processor by the another job assigning apparatus which is managed by the managing section based on the acquired number of processes of the job assigned to the job processor by the another job assigning apparatus.

13. A control method of a job assigning apparatus connected to a plurality of job processors for processing a job and assigns the job to any of the job processors, the control method comprising:
accepting the job;
selecting a job processor in which the number of processes assigned to each of the job processors is least from among the plurality of job processors;
assigning the accepted job to the selected job processor;
managing each of the job processors and the number of processes of the job assigned to each of the job processors in association with each other;
adding the number of processes of the assigned job to the number of processes associated with the job in the job processor to which the job is assigned; and
notifying another job assigning apparatus for assigning a job to a job processor of the number of processes of the assigned job.

14. The control method of the job assigning apparatus according to claim 13, the control method further comprising:
managing a job processor to which a job is assigned by the another job assigning apparatus and the number of processes of the job assigned to the job processor by the another job assigning apparatus in association with each other;
receiving notification indicating the number of processes of the job assigned to the job processor by the another job assigning apparatus from the another job assigning apparatus; and
updating the managed number of processes of the job assigned to the job processor by the another job assigning apparatus based on the received number of processes of the job assigned to the job processor by the another job assigning apparatus.

15. The control method of the job assigning apparatus according to claim 13, the control method further comprising:
subtracting, the number of processes of the terminated job from the number of processes of the job assigned to the job processor when receiving termination notification indicating that the job processor terminates the assigned job from the job processor; and
notifying the another job assigning apparatus of the number of processes of the job terminated in the job processor.

16. The control method of the job assigning apparatus according to claim 14, the control method further comprising:
receiving the number of processes of the terminated job out of jobs assigned to the job processor by the another job assigning apparatus notified from the another job assigning apparatus; and
subtracting the number of processes of the terminated jobs notified from the another job assigning apparatus from the managed number of processes of the job assigned to the job processor.

17. The control method of the job assigning apparatus according to claim 14, the control method further comprising:
receiving operation stop information indicating stop of operation of the another job assigning apparatus; and
subtracting the number of processes of the job assigned to the job processor by the another job assigning apparatus from the managed number of processes of the job assigned to the job processor upon reception of the operation stop information.

18. The control method of the job assigning apparatus according to claim 14, the control method further comprising:
acquiring the number of processes of the job assigned to the job processor by the another job assigning apparatus from the another job assigning apparatus upon activation of the job assigning apparatus; and
updating the managed number of processes of the job assigned to the job processor by the another job assigning apparatus based on the acquired number of processes of the job assigned to the job processor by the another job assigning apparatus.
